(19) United States
(12) Patent Application Publication
(10) Pub. No.: US 2006/0124254 A1
(43) Pub. Date: Jun. 15, 2006

(54) Light leaves of a Venetian blind and their manufacturing method

(75) Inventors: Ming Nien, Taichung (TW); Dong-Jung Chen, Taichung (TW)

Correspondence Address: TROXELL LAW OFFICE PLLC, SUITE 1404, 5205 LEESBURG PIKE, FALLS CHURCH, VA, 22041, US

(73) Assignee: Nien Made Enterprise Co., Ltd.

(21) Appl. No.: 11/011,124

(22) Filed: Dec. 15, 2004

(51) Int. Cl. E06B 3/12

(52) U.S. Cl. 160/236

(57) ABSTRACT

Light leaves of a Venetian blind and their manufacturing method, that is first to make a plastic basic plate by a plastic injection molding machine. Then, the plastic basic plate is cut in shape and punched with grooved slots to make up leaves of a Venetian blind. Each leaf is formed with two parallel long-stripped leaf surfaces and plural parallel separating plates formed integral between the two leave surfaces, having a through vent hole formed between every two adjacent separating plates and the two leaf surfaces. Such leaves are light and have functions of sound and heat insulation.

### BACKGROUND OF THE INVENTION

1. Field of the Invention

This invention relates to light leaves of a Venetian blind and their manufacturing method, particularly to one having interior hollows and a manufacturing method including steps of plastic injection molding, cutting and punching, able to produce hollow leaves of a Venetian blind.

2. Description of the Prior Art

The leaves of a convention Venetian blind, whether vertical or horizontal, are generally composed of an upper rail, a lower rail, a plurality of leaves, a pull cord and an adjusting rod. Most of the leaves of the conventional Venetian blind are solid to be unfolded and collapsed by the pull cord and moved bias for certain angles by the adjusting rod for the purpose of blocking and transmitting light.

However, being solid in structure, each leaf of the conventional Venetian blind is comparatively heavy; therefore, it is necessary for a user to apply a comparatively great force for collapsing the leaves or adjusting them to move biasly.

### SUMMARY OF THE INVENTION

The objective of the invention on is to offer light leaves of a Venetian blind and their manufacturing method, in which a plastic basic plate is first injection molded by a plastic injection molding machine. Then, the plastic basic plate is properly cut in shape and punched with grooved slots to make up leaves that respectively have two parallel long-stripped leaf surfaces and a plurality of parallel separating plates formed integral between the two leaf surfaces, with a through vent hole defined between every two adjacent separating plates and the two leave surfaces.

The hollow leaves of a Venetian blind in this invention are light and effective for sound and heat insulation.

### BRIEF DESCRIPTION OF DRAWINGS

This invention will be better understood by referring to the accompanying drawings, wherein:

FIG. 1 is a perspective view of a first-typed leaf of a Venetian blind in the present invention:

FIG. 2 is a side-sectional view of the leaf of a Venetian blind in the present invention:

FIG. 3 is a perspective view of a second-typed leaf of a Venetian blind in the present invention:

FIG. 4 is a process view of making leaves of a Venetian blind in the present invention:

FIG. 5 is a perspective view of a third-typed leaf of a Venetian blind in the present invention: and

FIG. 6 is a perspective view of the leaves applied to a Venetian blind in the present invention.

### DETAILED DESCRIPTION OF THE PREFERRED EMBODIMENT

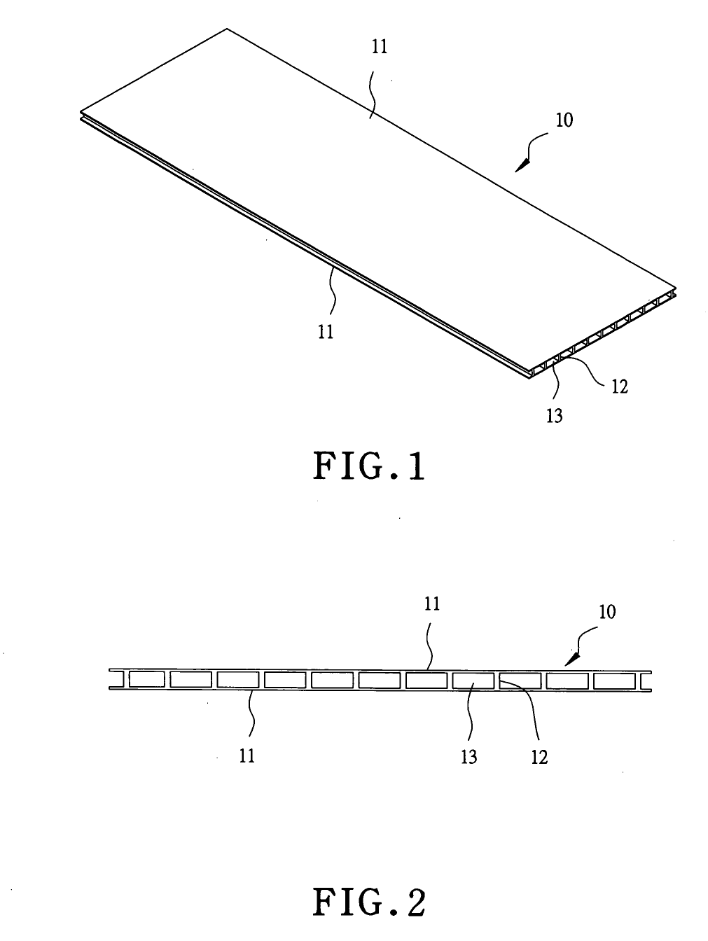

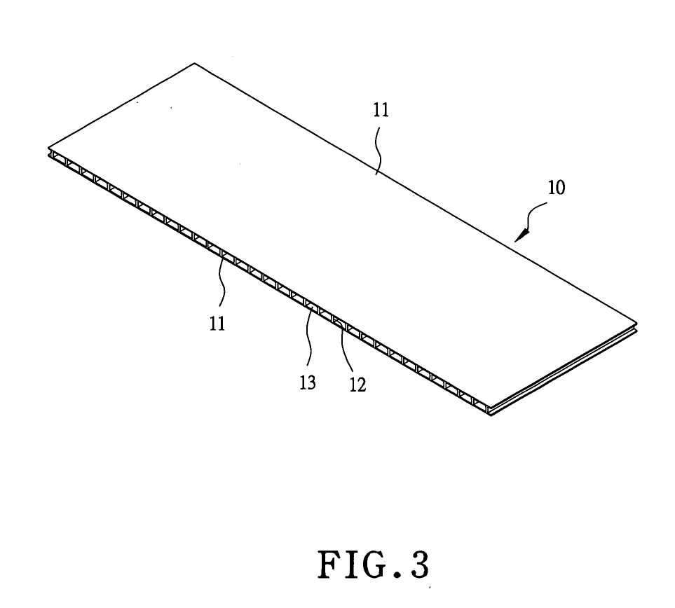

A preferred embodiment of the leaf of a Venetian blind, which is produced in the present invention, as shown in FIGS. 1 and 2, includes two parallel long-stripped leaf surfaces 11 and a plurality of parallel separating plates 12 formed integral between the two leaf surfaces 11, with a through vent hole 13 defined between every two adjacent separating plates 12 and the two leaf surfaces 11. The vent hole 13 could be parallel to the long sides of the leaves 10, as shown in FIG. 1, or parallel to the short sides of the leaves 10, as shown in FIG. 3.

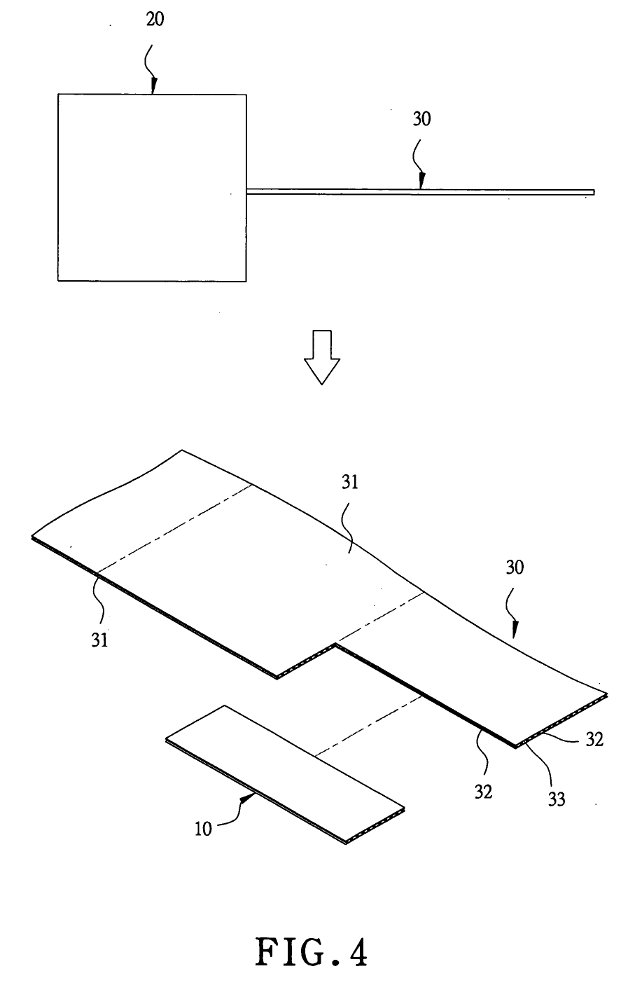

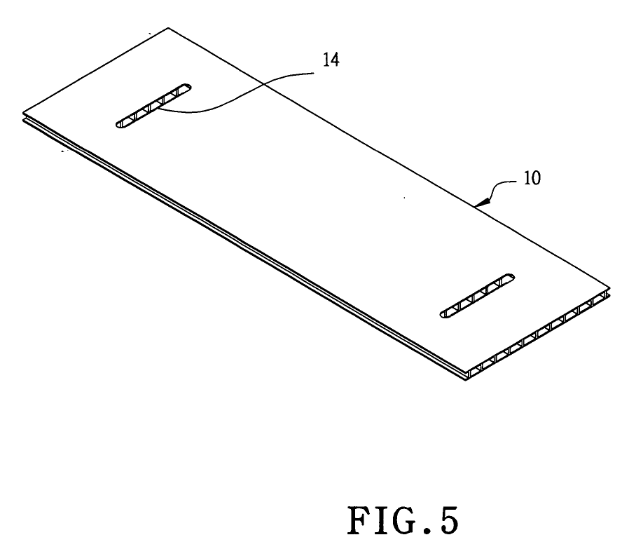

A preferred embodiment of a manufacturing method for light leaves 10 of a Venetian blind in the present invention, as shown in FIG. 4, includes the following steps: Firstly, plastic material, such as PVC (polyvinyl chloride), PP (poly propylene) or ABS (acrylonitrile-butadiene-styrene), is poured into a plastic injection molding machine 20 and mixed therein with other chemical prescription and the mixture is stirred and blended together. Subsequently, a long-stripped plastic basic plate 30 is blow molded by the plastic injection molding machine 20, having two parallel leave surfaces 31 and a plurality of parallel separating plates 32 formed integral between the two leaf surfaces 31 as well as a through vent hole 33 formed between every two adjacent separating plates 32 and the two leaf surfaces 31. Next, the plastic basic plate 30 is lengthwise cut into leaves 10 of a specific length and width for matching with different-sized Venetian blinds.

In a producing process of leaves 10, the plastic basic plate 30 can be orderly punched with plural grooved slots (not shown) at proper locations so that, after the plastic basic plate 30 is cut into leaves 10, each leaf 10 can be formed with two cord-inserting slots 14.

Further, in the producing process of leaves 10, proper dye can be added to the plastic material for producing different-colored leaves 10 after blow molded and cut in shape, able to elevate visual effects. Furthermore, proper wood flour can be added to the plastic material for producing imitative wood leaves 10 after blow molded and cut in shape, presenting excellent feeling of quality.

In addition, after the plastic basic plate 30 is blow molded but not completely hardened into shape, the leave surfaces 31 of the plastic basic plate 30 can be rolled and compressed by a special roller to form solid wood grain thereon. Thus, the leaves 10, after cut in shape, have their surfaces 11 formed with wood grain to increase visual effects.

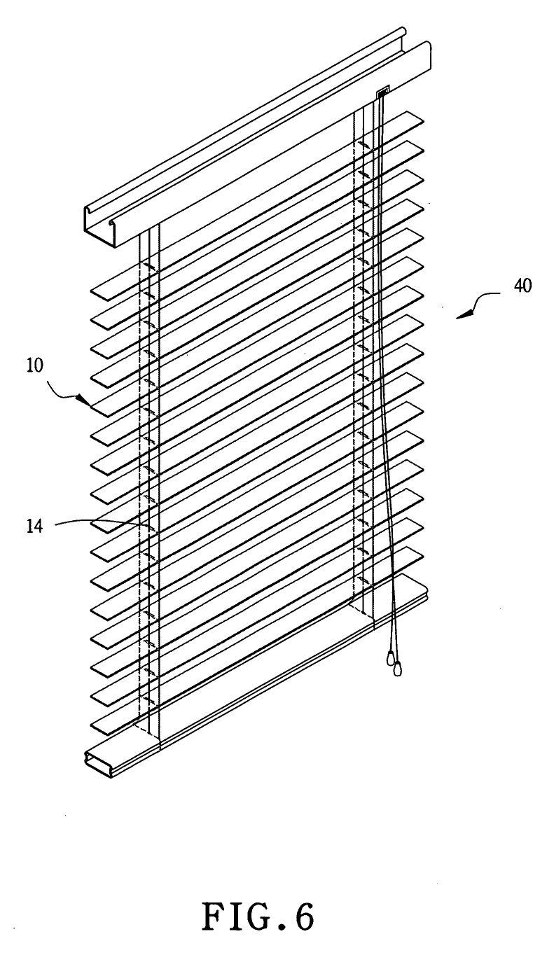

The leaves 10 of this invention are applicable to either a vertical or a horizontal Venetian blind. The leaves 10 in this preferred embodiment are applied to a horizontal Venetian blind 40, as shown in FIG. 6. To sum up, the leaves 10 of a Venetian blind, produced in the present invention, have the following advantages.

1. The leaves 10 are made of plastic material of comparatively small specific gravity, having interior hollows so they are light and can be operated easily and conveniently by a pull cord or an adjusting rod.

2. The leaves 10 are hollow in structure with through vent holes 13, having effects of sound and heat insulation.

3. The leaf surfaces 11 of the leaves 10 can be made into different thicknesses to produce translucent or opaque leaf surfaces 11.

4. Different dyes can be added to the plastic material for making different-colored leaves 10.

5. The leaf surface 11 of the leaves 10 can be rolled and compressed by a special roller to form wood grain thereon.

6. Wood flour can be added to the plastic material for making imitative wood leaves 10 to substitute for genuine wood leaves.

7. The hollow leaves 10 are better than conventional solid leaves in heat resistance.

8. There are various kinds of plastic materials, such as PVC (polyvinyl chloride) or PP (polypropylene) or ABS (acrylonitrile-butadiene-styrene), to be freely selected for use.

While the preferred embodiment of the invention has been described above, it will be recognized and understood that various modifications may be made therein and the appended claims are intended to cover all such modifications that may fall within the spirit and scope of the invention.

I claim:

1. A light leaf of a Venetian blind comprising two parallel long-stripped leaf surfaces and a plurality of parallel separating plates formed integral between said two leave surfaces.

2. The light leaf of a Venetian blind as claimed in claim 1, wherein a through vent hole is defined between every two adjacent said separating plates and said two leaf surfaces.

3. The light leaf of a Venetian blind as claimed in claim 1, wherein the outer sides of said leaf surfaces are formed integral with wood grain.

4. The light leaf of a Venetian blind as claimed in claim 1, wherein at least one cord-inserting slot is bored at preset locations between said two leaf surfaces of said leave.

5. The light leaf of a Venetian blind as claimed in claim 1, wherein said vent holes are parallel to the long sides of said leaf surfaces.

6. The light leaf of a Venetian blind as claimed in claim 1, wherein said vent holes are parallel to the short sides of said leaf surfaces.

7. The light leaf of a Venetian blind as claimed in claim 1, wherein said leaves are integrally made of plastic material.

8. A manufacturing method for said light leaves of a Venetian blind as claimed in claim 1 comprising the following steps: firstly, plastic material injection molded into a long-stripped plastic basic plate by a plastic injection molding machine, said plastic basic plate having two parallel leave surfaces and a plurality of parallel separating plates formed integral between said two leaf surfaces, with a through vent hole defined between every two adjacent said separating plates and said two leaf surfaces, secondly, said plastic basic plate lengthwise cut into leaves of specific lengths and widths in accordance with different-sized Venetian blinds.

9. The manufacturing method for said light leaves of a Venetian blind as claimed in claim 8, wherein said plastic material is PVC (polyvinyl chloride) or PP (polypropylene) or ABS (acrylonitrile-butadiene-styrene).

10. The manufacturing method for said light leaves of a Venetian blind as claimed in claim 8, wherein proper dye is added to said plastic material for producing different-colored leaves after injection molded and cut in shape.

11. The manufacturing method for said light leaves of a Venetian blind as claimed in claim 8, wherein proper wood flour is added to said plastic material for producing imitative wood leaves after injection molded and cut in shape.

12. The manufacturing method for said light leaves of a Venetian blind as claimed in claim 8, wherein the leaf surfaces of said plastic basic plate are rolled and compressed by a special roller before said plastic basic plate is hardened in shape so as to produce leaves having wood grain formed on their outer surfaces after said leaves are cut in shape.

13. The manufacturing method for said light leaves of a Venetian blind as claimed in claim 8, wherein the leaf surfaces of said plastic basic plate are punched with grooved slots so that each said leaf, after cut in shape, is formed with two cord-inserting slots.
